(19) United States
(12) Patent Application Publication
(10) Pub. No.: US 2020/0319000 A1
(43) Pub. Date: Oct. 8, 2020

(54) METHOD FOR CORRECTING MEASUREMENT DATA OF AN ANALYSIS SENSOR AND ANALYSIS SENSOR WITH CORRECTION OF MEASUREMENT DATA

(71) Applicant: Endress+Hauser Conducta GmbH+Co. KG, Gerlingen (DE)

(72) Inventor: Michael Hanko, Dresden (DE)

(21) Appl. No.: 16/843,614

(22) Filed: Apr. 8, 2020

(30) Foreign Application Priority Data
Apr. 8, 2019 (DE) 10 2019 109 197.7

(51) Int. Cl. G01D 5/244; G01N 27/416; G01D 3/036; G01D 18/00

(52) U.S. Cl. CPC G01D 5/24485; G01N 27/4163; G01D 5/2449; G01D 18/008; G01D 3/0365; G01D 5/2448; G01D 5/24452

(57) ABSTRACT

The present disclosure relates to a method for correcting measurement data of an analysis sensor. The method includes providing an analysis sensor having a first sensor unit, a data memory and a computing unit. The data memory has sensor-specific or sensor-type-specific parameter data which represent a predetermined field of application of the analysis sensor. The method also includes collecting measurement data through the first sensor unit, reading out the sensor-specific parameter data from the data memory through the computing unit, and correcting the collected measurement data using the sensor-specific parameter data through the computing unit in order to generate corrected measurement data.

### CROSS-REFERENCE TO RELATED APPLICATION

The present application is related to and claims the priority benefit of German Patent Application No. 10 2019 109 197.7, filed on Apr. 8, 2019, the entire contents of which are incorporated herein by reference.

### TECHNICAL FIELD

The present disclosure relates to two methods for correcting measurement data of an analysis sensor and to an analysis sensor with correction of measurement data.

### BACKGROUND

In analytical measurement technology, especially in the fields of water management and environmental analysis and in industry, for example in food technology, biotechnology and pharmaceuticals, as well as for various laboratory applications, measurands such as pH value, conductivity or the concentration of analytes such as ions or dissolved gases in a gaseous or liquid measurement medium are vitally important. These measurands can be detected and/or monitored by means of, for example, analysis sensors such as potentiometric, amperometric, voltammetric, or coulometric sensors, which are all known per se from the prior art.

Such analysis sensors are generally operated on a superordinated device, for example a measurement transducer or measurement value transmitter.

Depending on the technical design of the analysis sensor and depending on the field of application, analysis sensors are exposed to quite specific operating conditions, e.g. specific temperature ranges, specific pH ranges, etc. The operating conditions of an analysis sensor can influence, i.e. falsify, the measurement values measured by the analysis sensor. Furthermore, differently designed analysis sensors and sensor types for determining the same measurand can have different behavior with regard to their measurement properties or other dependencies on the operating conditions. So that this sensor-specific behavior can be taken into account in the evaluation of measurement values and thus the measurement values are not falsified and measurement values do not differ under the same operating conditions for differently designed analysis sensors, the operating conditions of the analysis sensor and properties arising from the design of the analysis sensor must be stored by the user in the form of sensor-specific parameter data in the superordinate external device connected to the analysis sensor.

By means of the sensor-specific parameterization, the measurement values determined by the analysis sensor can then be corrected in the analysis sensor or in a device connected to the analysis sensor; that is to say, they can be adapted to the operating conditions. Furthermore, the sensor-specific parameterization enables the evaluation of sensor states; for example, whether characteristic curves have shifted, or whether the analysis sensor has passed through the maximum permissible number of sterilization or cleaning processes for the particular sensor type.

However, this sensor-specific parameterization is time-consuming for the user and can lead to measurement errors by the analysis sensor in the event of incorrect settings. Particularly if the user wishes to parameterize a plurality of analysis sensors, each of which is operated under different operating conditions, the risk of an incorrect setting by the user is especially high, since the user must carry out a plurality of different parameterizations which must not be confused with each other.

### SUMMARY

It is therefore an object of the present disclosure to propose a method which enables reliable and convenient sensor-specific parameterization of an analysis sensor. The method includes correcting measurement data of an analysis sensor. The method also includes providing an analysis sensor having a first sensor unit, a data memory and a computing unit, where the data memory has sensor-specific and/or sensor-type-specific parameter data which represent a predetermined field of application and/or a measurement characteristic of the analysis sensor. The method also includes collecting measurement data through the first sensor unit, reading out the parameter data from the data memory through the computing unit, and correcting the collected measurement data by means of the parameter data through the computing unit in order to generate corrected measurement data.

The step of collecting measurement data can naturally also comprise conversion of analog into digital measurement data according to the prior art. The method according to the present disclosure makes it possible for the measurement data determined by the analysis sensor to be corrected in a convenient and reliable manner. The sensor-specific and/or sensor-type-specific parameter data provided in the data memory of the analysis sensor enable the user to minimize manual input in order to take into account the operating conditions of the analysis sensor. Input errors by the user are thus avoided and convenience of use of the analysis sensor is increased.

In one embodiment of the present disclosure, the analysis sensor has a first communication module and is adapted to be connected to a second communication module of a device external to the analysis sensor in order to transmit the corrected measurement data from the analysis sensor to the device.

The method according to the present disclosure for correcting measurement data of an analysis sensor comprises providing an analysis sensor having a first sensor unit, a data memory and a first communication module. The data memory has sensor-specific and/or sensor-type-specific parameter data which represent a predetermined field of application and/or a measurement characteristic of the analysis sensor. The first communication module is adapted to be connected to a second communication module of a device external to the analysis sensor. The method also includes steps of providing the device external to the analysis sensor having the second communication module and a computing unit, connecting the second communication module to the first communication module, transmitting the sensor-specific and/or sensor-type-specific parameter data from the analysis sensor to the external device through the first communication module and the second communication module, and collecting measurement data through the first sensor unit of the analysis sensor. The method also includes steps of transmitting the collected measurement data from the analysis sensor to the external device through the first communication module and the second communication module, and correcting the collected measurement data by means of the sensor-specific and/or sensor-type-specific parameter data through the computing unit of the external device in order to generate corrected measurement data.

In one embodiment of the present disclosure, the first sensor unit of the analysis sensor has a sensor-specific and/or sensor-type-specific first zero or operating point and the sensor-specific parameter data comprise a sensor-specific and/or sensor-type-specific value for a zero or operating point shift and the step of correcting the collected measurement data comprises a change to the collected measurement data such that the corrected measurement data correspond to the measurement data of a second sensor unit having a second zero or operating point which is shifted relative to the first zero or operating point of the first sensor unit by the value of the zero or operating point shift.

In one embodiment of the present disclosure, the first sensor unit of the analysis sensor has a sensor-specific and/or sensor-type specific first reference system and the parameter data comprise a sensor-specific and/or sensor-type-specific offset value for a reference system shift, and the step of correcting the collected measurement data comprises a change to the collected measurement data such that the corrected measurement data correspond to the measurement data of a second sensor unit having a second reference system shifted relative to the first reference system by the offset value.

In one embodiment of the present disclosure, the sensor-specific or sensor-type-specific parameter data comprise a regression function for changing, especially for linearizing the temperature dependence of the collected measurement data, and the step of correcting the collected measurement data comprises a change to the collected measurement data such that the corrected measurement data have a changed, especially largely linear temperature dependence.

In one embodiment of the present disclosure, the parameter data comprise at least one sensor-specific and/or sensor-type-specific first default value for a sensor-specific and/or sensor-type-specific evaluation of a sensor state of the sensor unit.

The method according to the present disclosure further comprises a step of transmitting the first default value from the analysis sensor to the external device through the first communication module and the second communication module.

In one embodiment of the present disclosure, the external device comprises a data memory, and the method further comprises the step of storing the first default value in the data memory of the external device.

In one embodiment of the present disclosure, the method further comprises comparing the first default value to a sensor-specific and/or sensor-type-specific second default value stored in the data memory of the external device, and generating a user message if the first default value is different from the second default value.

In one embodiment of the present disclosure, the step of comparing the first default value and the second default value is performed with the aid of a hash function or a checksum.

The analysis sensor according to the present disclosure for correcting measurement data comprises a first sensor unit, a data memory and a computing unit, wherein the data memory has sensor-specific and/or sensor-type-specific parameter data which represent a predetermined field of application and/or a measurement characteristic of the analysis sensor and/or a specific measurement characteristic of the analysis sensor.

### BRIEF DESCRIPTION OF THE DRAWINGS

The present disclosure is explained in more detail on the basis of the following description of the figures.

FIG. 1 shows a schematic representation of an analysis sensor according to the present disclosure which has sensor-specific and/or sensor-type-specific parameter data and a computing unit;

FIG. 2 shows a schematic representation of an alternative analysis sensor according to the present disclosure which has sensor-specific and/or sensor-type-specific parameter data and is connected to an external device having a computing unit; and

FIG. 3 shows a schematic representation of an alternative embodiment of the analysis sensor represented in FIG. 2.

### DETAILED DESCRIPTION

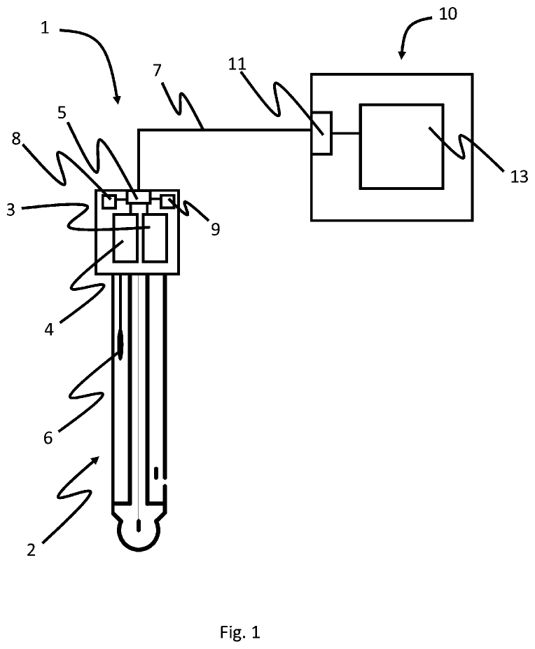

FIG. 1 shows a first embodiment of an analysis sensor 1 according to the present disclosure for correcting measurement data. The analysis sensor 1 comprises a sensor unit 2, a data memory 3, a computing unit 4 and a communication module 5. In FIG. 1, the analysis sensor 1 is connected to an external device 10 which has a communication module 11 and, optionally, a display unit 13. The external device 10 can furthermore be connected to further superordinate units for collecting and processing measurement data, for example a process control system, via a data connection according to the prior art.

The sensor unit 2 is adapted to be immersed in a medium, for example a liquid, in order to measure a measurand, e.g. the pH value of the medium. In this case, the analysis sensor 1 is a pH sensor. Of course, the analysis sensor 1 can also be configured as another electrochemical sensor or an optochemical sensor or a conductivity sensor or an analysis sensor for measuring other measurands.

The data memory 3 of the analysis sensor 1 comprises sensor-specific and/or sensor-type-specific parameter data. The parameter data are written into the data memory 3 in such a way that they are available for the computing unit 4 and/or the communication module 5. The parameter data enable a configuration of the analysis sensor 1 such that a predetermined field of application and/or a measurement characteristic or sensor-specific or sensor-type-specific properties of the analysis sensor 1 are represented.

The parameter data include, for example, default values for a sensor-specific and/or sensor-type-specific evaluation of the state of the sensor unit 2 and/or for correction and/or modification of measurement data determined using the sensor unit 2.

For example, the parameter data describe a recommended maximum deviation of the sensor slope, a recommended maximum deviation of the sensor slope up to a warning and/or alarm, a recommended maximum deviation of the sensor slope for evaluation as good of a slope calibration, a recommended maximum deviation of the sensor zero or operating point, a recommended maximum deviation of the sensor zero or operating point sensor up to a warning and/or alarm, a recommended maximum deviation of the sensor zero or operating point sensor for evaluation as good of a zero or operating point calibration, a recommended maximum deviation of the sensor offset, a recommended maximum deviation of the sensor offset up to a warning and/or alarm, a recommended maximum deviation of the sensor offset for evaluation as good of an offset calibration, a recommended lower and/or upper warning and/or alarm threshold for the sensor internal resistance, a recommended lower and/or upper warning and/or alarm threshold for the sensor reference resistance, a recommended maximum number of hot steam sterilizations up to a warning and/or alarm and/or a recommended maximum number of sensor cleanings up to a warning and/or alarm.

The sensor-specific or sensor-type-specific parameter data can furthermore comprise a regression function and regression parameters for changing, especially for linearizing the temperature dependence of the collected measurement data.

The sensor-specific or sensor-type-specific parameter data may further comprise at least one value for changing the sensor characteristic. Examples of such values are a value for changing the sensor slope, a value for changing the sensor zero or operating point, a value for influencing the sensor linearity and/or a value for changing the sensor offset.

The computing unit 4 is connected to the sensor unit 2 and the data memory 3. The computing unit 4 is adapted for accessing the parameter data in the data memory 3. The computing unit 4 is adapted for processing, for example correcting, especially using the parameter data, the measurement data measured by the sensor unit 2. Furthermore, the computing unit 4 is connected to the communication module 5. The computing unit 4 can especially transmit the processed, especially corrected measurement data to the communication module.

A correction of the measurement data is carried out by the computing unit 4 directly at the location of generation of the measurement data, namely in the analysis sensor. This enables, for example, the use of the analysis sensor 1 together with an external device 10, for example a transmitter, which does not have a computing unit for correcting the measurement data, as is the case with older or energy-saving transmitters. Thus, the analysis sensor 1 is adapted for preparing corrected measurement data, i.e. measurement data which take into account the sensor-specific operating conditions or sensor-specific or sensor-type-specific measurement characteristics, for external devices 10.

The communication module 5 is adapted to be connected to a second communication module 11 of a device 10 external to the analysis sensor 1. The communication module 5 is adapted for sending and/or providing the measured measurement data and/or the corrected measurement data to the second communication module 11.

By means of the communication module 5, it is possible to provide the external device 10 with the corrected measurement data. The optionally present display unit 13 of the external device 10 enables display of the corrected measurement data.

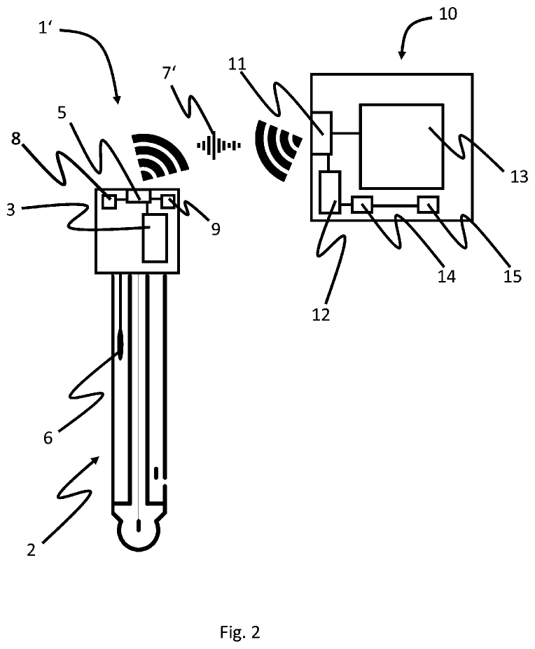

In the embodiment shown in FIG. 1, the communication module 5 of the analysis sensor 1 is connected via a cable connection 7 to the communication module 11 of the external device 10, for example a measurement transducer. Of course, the connection between the communication module 5 and the communication module 11 can also be established by any other data connection according to the prior art, for example by a cable connection with an inductive interface or by a radio link 7′ (see FIG. 2).

In a complementary embodiment, the sensor unit 2 further comprises a temperature sensor 6. The temperature sensor 6 is adapted for determining the temperature of the measurement medium or the sensor unit 2 and for providing it to the computing unit 4 and/or the communication module 5 in analog or digital form. This enables, for example, a temperature-dependent correction of a measurement value determined by sensor unit 2.

FIG. 2 shows a second embodiment of the analysis sensor that is an alternative to the first embodiment. The difference in this second embodiment is that the analysis sensor 1′ has no computing unit 4, but the external device 10 has a computing unit 12 instead.

The computing unit 12 of the external device 10 is adapted for converting the determined measurement data received from the analysis sensor 1′ into corrected measurement data with the aid of the sensor-specific and/or sensor-type-specific parameter data likewise provided by the analysis sensor 1′. In other words, the processing, especially the correction, of the measurement data does not take place in the analysis sensor 1′ but in the external device 10.

The second embodiment allows the analysis sensor 1′ to require less energy than the analysis sensor 1 described in the first embodiment. Such an analysis sensor 1′ can be used, for example, in areas exposed to explosions hazards. The manufacturing costs of such an analysis sensor 1′ are thus kept to a minimum. Given the presence of the computing unit 12 in the external device 10, it is possible to carry out the measurement data processing, i.e. the correction of the measured values as well as the measured value conversion and/or measured value display, in a single device.

Of course, it is possible to operate the external device 10 having the computing unit 12 together with an analysis sensor 1 which has the computing unit 4.

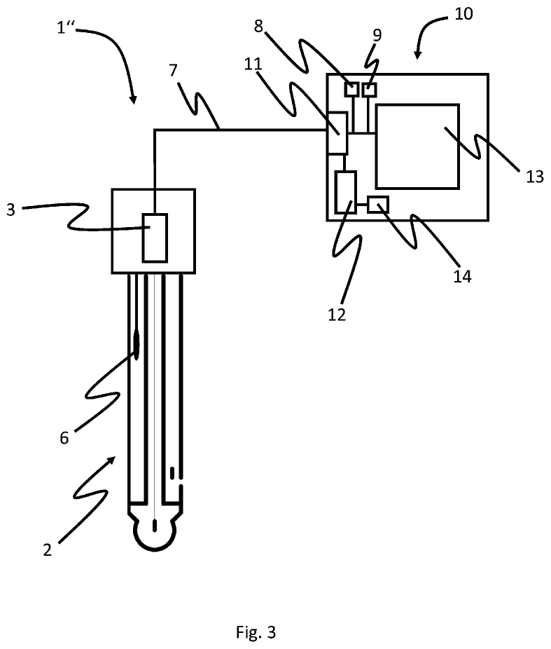

FIG. 3 shows a third embodiment of the analysis sensor that is an alternative to the second embodiment. The difference from the analysis sensor 1′ is that the analysis sensor 1″ has no communication module 5. However, the communication link between the analysis sensor 1″ and the external device 10 is limited here to a cable connection 7. The cable connection 7 is directly connected to the data memory 3 of the analysis sensor 1″. The external device 10 thus gains direct access to the parameter data which are available in the data memory 3 in a retrievable manner.

In all embodiments represented in FIGS. 1-3, the sensor unit 2 of the analysis sensor 1, 1′, 1″ can have a first sensor-specific and/or sensor-type-specific zero or operating point. The parameter data further comprise a sensor-specific and/or sensor-type-specific value for a zero or operating point shift.

In all embodiments represented in FIGS. 1-3, the sensor unit 2 of the analysis sensor 1, 1′, 1″ can have a sensor-specific and/or sensor-type-specific first measurement value deviation. The parameter data further comprise a sensor-specific and/or sensor-type-specific offset value for a reduction of the measurement value deviation.

In all embodiments represented in FIGS. 1-3, the analysis sensor 1, 1′, 1″ or the external device 10 may comprise a sterilization counter 8. In this case, the parameter data further comprise default values for a sterilization temperature value and a sterilization duration value, wherein the sterilization temperature value used for counting a sterilization and the sterilization duration value can be set by the user and the sterilization counter recognizes a sterilization of the analysis sensor 1, 1′, 1″ if the temperature measured by the temperature sensor is above the sterilization temperature value for a duration longer than the sterilization duration value. Thus, the user can adapt the sterilization counter to a desired process. Similarly, the analysis sensor 1, 1′, 1″ or the external device 10 may comprise a cleaning counter 9 for automatically detecting a chemical cleaning of the sensor unit 2. In this case, the parameter data further comprise default values for a cleaning temperature value and a cleaning duration value.

The correction method for the measurement data will be described in detail below. Reference is hereby made to FIG. 1 for the sake of simplicity. Steps which are not realized in the embodiment represented in FIG. 1 are mentioned separately below. Otherwise, all steps are also used in the embodiments and corresponding correction methods represented in FIG. 2 and FIG. 3.

First, the analysis sensor 1 collects the measurement data by means of the sensor unit 2. For this purpose, the sensor unit 2 is of course in contact with the medium to be analyzed, for example with a liquid. The collection of the measurement data can also comprise the collection of temperature data which are determined by means of the temperature sensor 6 of the analysis sensor and/or the conversion of analog into digital measurement data. The necessity of collecting the temperature data in addition to collecting the measurement data depends on the type of analysis sensor. For a pH sensor, for example, the collection of temperature data is advantageous.

The sensor-specific and/or sensor-type-specific parameter data are further read out from the data memory 3 of the analysis sensor with the aid of the computing unit 4.

In a further step, the collected measurement data are converted into corrected measurement data. The parameter data are used for this. The conversion or generation of the corrected measurement data is carried out by the computing unit 4.

Optionally, the analysis sensor 1 may be connected to an external device 10 in order to transmit the corrected measurement data to the external device 10. For this purpose, the communication module 5 of the analysis sensor 1 is connected to the communication module 11 of the external device 10. Then, the corrected measurement data is transmitted to the external device 10. The corrected measurement data can be transmitted via a cable connection 7 or alternatively via a radio link 7′.

The method for correcting the measurement data corresponding to the alternative embodiment represented in FIG. 2 differs from the method corresponding to the embodiment represented in FIG. 1 in that the step of transmitting the measurement data of the analysis sensor 1′, 1″ to the external device 10 takes place before the step of correcting the collected measurement data.

As mentioned above, the measurement data may, for example, also comprise temperature data from a temperature sensor 6.

In this alternative method, the step of correcting the collected measurement data is performed by the computing unit 12 of the external device 10. The likewise transmitted sensor-specific and/or sensor-type-specific parameter data are used to correct the measurement data.

The method for correcting the measurement data corresponding to the alternative embodiment represented in FIG. 3 differs from the method corresponding to the embodiment represented in FIG. 2 in that the communication link between the analysis sensor 1″ and the external device 10 is established by means of a cable connection.

The methods corresponding to the embodiments represented in FIGS. 2-3 may optionally comprise the step of the second communication module 11 transmitting the first default value from the analysis sensor 1′, 1″ to the external device 10. For this purpose, the second communication module 11 reads out the first default value from the data memory 3 of the analysis sensor 1″.

The methods corresponding to the embodiments represented in FIGS. 2-3 may optionally comprise the step of storing the first default value in the data memory 14 of the external device 10.

The methods corresponding to the embodiments represented in FIGS. 2-3 may optionally comprise a step of comparing the first default value to a second sensor-specific and/or sensor-type-specific default value stored in the data memory 14 of the external device 10 and a step of generating a user message if the first default value is different from the second default value.

In all the methods corresponding to the embodiments represented in FIGS. 1-3, the step of processing, especially correcting the collected measurement data, can optionally take place in such a way that the corrected measurement data corresponds to a second sensor unit having a second zero or operating point which is shifted relative to the first zero or operating point of the first sensor unit 2 by the value of the zero or operating point shift.

This allows the use of different types of analysis sensors without the customer having to adapt the procedures and threshold values prescribed for the standard type. As an example of this, a pH sensor with a zero point deviating from the usual zero point of pH 7, for example a sensor with what is called a pH solid contact, can be applied by the user like a pH sensor with a usual zero point without adaptation of threshold values or standard procedures.

In all methods corresponding to the embodiments represented in FIGS. 1-3, the step of correcting the collected measurement data may optionally comprise a change to the collected measurement data such that the corrected measurement data correspond to the measurement data of a second sensor unit having a second reference system which is shifted by the offset value relative to the first reference system of the first sensor unit 2. This makes it possible, for example, to use alternative reference systems with different electrical reference potentials in redox sensors without the user having to make changes to the design and parameterization of the measuring point.

This allows the analysis sensor to be used without the customer having to adapt previously used threshold values or standard procedures for the use of the analysis sensor.

In all the methods corresponding to the embodiments represented in FIGS. 1-3, the step of correcting the collected measurement data may optionally comprise a change to the collected measurement data such that the corrected measurement data have a linear temperature dependence. The corrected measurement data of pH sensors especially have a linear temperature dependence corresponding to the Nernst equation. In this way, for example, the temperature dependence of the pH value of the liquid contact of pH glass electrodes can be corrected. For this purpose, the pH change of the liquid contact as a function of the temperature must be determined once and a corresponding function or regression function as well as the associated coefficients must be determined and stored in the data memory 3 of the pH sensor as sensor-type-specific parameter data.

The corrected measurement data are preferably the same measurand as the determined measurement data. This makes it possible to design the analysis sensors to be compatible with external devices 10 hitherto used in practice. If, for example, in previous pH sensors, the pH-dependent measurement voltage was transmitted to the external device, then the measurement values corrected by the methods proposed here should likewise be made available as corrected pH-dependent measurement voltages. In this respect, the methods proposed here for processing, especially for correcting measurement data, differ from the calibration and adjustment customary for analysis sensors in that such customary methods generally comprise a change in the measurands; for example, the conversion of a pH-dependent measurement voltage and a measurement temperature into a temperature-compensated pH value. A further difference from the customary calibration and adjustment of analysis sensors is the fact that the sensor-specific and/or sensor-type-specific parameter data are written into the data memory 3 of the analysis sensor once, preferably after the manufacture of a corresponding analysis sensor, and are not changed over the duration of use of the analysis sensor. In other words, this involves an adjustment of the analysis sensor performed by the manufacturer which changes the measurement characteristic of the analysis sensor in a deliberate manner; it does not, however, replace or render superfluous calibration and adjustment of the analysis sensor to compensate for changes in the measurement characteristic occurring during use of the analysis sensor.

In all methods corresponding to the embodiments represented in FIGS. 1-3, the sensor-specific and/or sensor-type-specific parameter data can be written into the data memory 3 during the manufacture of an analysis sensor 1, 1′, 1″. The sensor-specific and/or sensor-type-specific parameter data can be determined in advance in a sensor-specific and/or sensor-type-specific manner. The sensor-specific and/or sensor-type-specific parameter data can be protected from being changed or overwritten after it is written into the data memory 3, especially from being changed or overwritten by the external device 10.

In one embodiment of the method, as represented in FIG. 2, the external device 10 comprises a further data memory 15 in which, after connecting an analysis sensor 1′ to the external device 10 via the communication modules 5 and 11, the transmitted sensor-specific and/or sensor-type-specific first default value is stored as the previous sensor-specific and/or sensor-type-specific second default value until an analysis sensor 1′ is again connected to the external device 10 via the communication modules 5 and 11. This can also take place in a manner that minimizes storage space as a hash or as a checksum.

In one embodiment of the method, the first sensor-specific and/or sensor-type-specific default value transmitted from the analysis sensor 1′ to the external device 10 is compared by the computing unit 12 of the external device 10 to the equivalent second default value stored in the data memory 14 and/or the third default value stored in the further data memory 15 as soon as the analysis sensor 1′ is connected to the external device 10 via the communication modules 5 and 11. In this case, the third default value is the default value which is used by the computing unit 12 for correcting and/or evaluating measurement data. In contrast to the first and second default values, the third default value can be changed by the user.

In one embodiment of the method, after connecting an analysis sensor 1′ via the communication modules 5 and 11, a user message is only generated if the at least one first default value transmitted by the analysis sensor 1′ differs from the equivalent second default value stored in the external device 10 and the data memory for the equivalent second default value is not empty and furthermore the third default value stored in the further data memory 15 differs from the transmitted first default value and the stored third default value is not empty.

1. A method for correcting measurement data of an analysis sensor, the method comprising the following steps:
providing an analysis sensor having a first sensor unit, a data memory and a computing unit,
wherein the data memory has sensor-specific or sensor-type-specific parameter data which represent a predetermined field of application or a measurement characteristic of the analysis sensor,
collecting measurement data through the first sensor unit,
reading out the parameter data from the data memory through the computing unit,
correcting the collected measurement data using the parameter data through the computing unit in order to generate corrected measurement data.

2. The method of claim 1, wherein the analysis sensor has a first communication module and is adapted to be connected to a second communication module of a device external to the analysis sensor in order to transmit the corrected measurement data from the analysis sensor to the device.

3. A method for correcting measurement data of an analysis sensor, wherein the method comprises the following steps:
providing an analysis sensor having a first sensor unit, a data memory and a first communication module,
wherein the data memory has sensor-specific or sensor-type-specific parameter data which represent a predetermined field of application or a measurement characteristic of the analysis sensor,
wherein the first communication module is adapted to be connected to a second communication module of a device external to the analysis sensor,
providing the device external to the analysis sensor having the second communication module and a computing unit,
connecting the second communication module to the first communication module,
transmitting the sensor-specific or sensor-type-specific parameter data from the analysis sensor to the external device through the first communication module and the second communication module,
collecting measurement data through the first sensor unit of the analysis sensor,
transmitting the collected measurement data from the analysis sensor to the external device through the first communication module and the second communication module,
correcting the collected measurement data using the sensor-specific or sensor-type-specific parameter data through the computing unit of the external device in order to generate corrected measurement data.

4. The method of claim 1, wherein the first sensor unit of the analysis sensor has a sensor-specific or sensor-type-specific first zero or operating point and sensor-specific parameter data comprise a sensor-specific or sensor-type-specific value of a zero or operating point shift and the step of correcting the collected measurement data comprises a change to the collected measurement data such that the corrected measurement data correspond to the measurement data of a second sensor unit having a second zero or operating point which is shifted relative to the first zero or operating point of the first sensor unit by the value of the zero or operating point shift.

5. The method of claim 1, wherein the first sensor unit of the analysis sensor has a sensor-specific or sensor-type-specific first reference system and the parameter data comprise a sensor-specific or sensor-type-specific offset value for a reference system shift and the step of correcting the collected measurement data comprises a change to the collected measurement data such that the corrected measurement data correspond to the measurement data of a second sensor unit having a second reference system which is shifted relative to the first reference system of the first sensor unit by the offset value.

6. The method of claim 1, wherein the sensor-specific or sensor-type-specific parameter data comprise a regression function for linearizing the temperature dependence of the collected measurement data, the method including a step of correcting the collected measurement data including changing the collected measurement data such that the corrected measurement data has a changed linear temperature dependence.

7. The method of claim 1, wherein the sensor-specific or sensor-type-specific parameter data comprise at least one sensor-specific or sensor-type-specific first default value for a sensor-specific or sensor-type-specific evaluation of a sensor state of the sensor unit.

8. The method of claim 3, wherein the method further comprises a step of transmitting the first default value from the analysis sensor to the external device via the first communication module and the second communication module.

9. The method of claim 8, wherein the external device comprises a data memory and the method further comprises the step of storing the first default value in the data memory of the external device.

10. The method of claim 9, wherein the method further comprises the following steps:
comparing the first default value to a sensor-specific or sensor-type-specific second default value stored in the data memory of the external device,
generating a user message if the first default value is different from the second default value.

11. The method of claim 10, wherein the step of comparing the first default value and the second default value is performed using of a hash function or a checksum.

12. An analysis sensor for correcting measurement data, comprising a first sensor unit, a data memory and a computing unit, wherein the data memory has sensor-specific or sensor-type-specific parameter data, said parameter data representing a predetermined field of application of the analysis sensor or a specific measurement characteristic of the analysis sensor.
